(19) United States
(12) Patent Application Publication
(10) Pub. No.: US 2025/0088976 A1
(43) Pub. Date: Mar. 13, 2025

(54) POWER CONTROL METHOD, APPARATUS AND TERMINAL DEVICE

(71) Applicant: Xi'an Unisoc Technologies Co., Ltd., Xi'an, Shaanxi (CN)

(72) Inventor: Haowen LIU, Xi 'an (CN)

(73) Assignee: Xi'an Unisoc Technologies Co., Ltd., Xi'an, Shaanxi, CN (CN)

(21) Appl. No.: 18/537,099

(22) PCT Filed: Jul. 28, 2023
(86) PCT No.: PCT/CN2023/110029

§ 371 Date: Dec. 12, 2023

(30) Foreign Application Priority Data
Jul. 29, 2022 (CN) 202210915306.4

(51) Int. Cl. H04W 52/24; H04L 5/00; H04W 64/00; H04W 92/18

(52) U.S. Cl. CPC H04W 52/242; H04L 5/0048; H04W 64/00; H04W 92/18

(57) ABSTRACT

The present disclosure provides a power control method, an apparatus and a terminal device, and is related to the technical field of communication. The method includes: transmitting SL-PRS according to a transmission power of the SL-PRS, where the transmission power of the SL-PRS is a minimum among a plurality of powers, and the plurality of powers include a maximum transmission power of the first terminal device and a first transmission power, and the first transmission power is a transmission power determined based on a path loss. The method realizes power control of the SL-PRS and can effectively reduce interference to other links.

### CROSS-REFERENCE TO RELATED APPLICATION

The present application is a National Stage of International Application No. PCT/CN2023/110029, filed on Jul. 28, 2023, which claims priority to Chinese Patent Application No. 202210915306.4, titled “POWER CONTROL METHOD, APPARATUS AND TERMINAL DEVICE”, filed to China National Intellectual Property Administration on Jul. 29, 2022, both of the above applications are incorporated herein by reference in their entireties.

### TECHNICAL FIELD

Embodiments of the present disclosure relate to the technical field of communication and, in particular, to a power control method, an apparatus and a terminal device.

### BACKGROUND

With the promotion of 3rd generation partnership project (3GPP), information exchange of vehicle-to-everything (V2X) in new radio (NR) is being studied widely and deeply. In the release 18 (R18) of protocol in 3GPP, the positioning technology of sidelink in the Internet of vehicles will be standardized. In order to support positioning function of the network terminal in the Internet of vehicles, it is necessary to introduce a sidelink positioning reference signal (SL-PRS) for positioning measurement.

### SUMMARY

Embodiment of the present disclosure provide a power control method, an apparatus and a terminal device.

In a first aspect, embodiments of the present disclosure provide a power control method, where the method is applied to a first terminal device, and the method includes: transmitting a SL-PRS according to a transmission power of the SL-PRS, where the transmission power of the SL-PRS is a minimum among a plurality of powers, and the plurality of powers include a maximum transmission power of the first terminal device and a first transmission power, and the first transmission power is a transmission power determined based on path loss.

In a second aspect, embodiments of the present disclosure provide a power control apparatus, including:
a transmitting module, configured to transmit a SL-PRS according to a transmission power of the SL-PRS, where the transmission power of the SL-PRS is a minimum among a plurality of powers, and the plurality of powers include a maximum transmission power of the apparatus and a first transmission power, and the first transmission power is a transmission power determined based on path loss.

In a third aspect, the present disclosure provides a chip on which a computer program is stored, and the computer program, when executed by the chip, realizes the method according to any one of the first aspects.

In a fourth aspect, the present disclosure provides a chip module, on which a computer program is stored, and the computer program, when executed by the chip module, realizes the method according to any one of the first aspects.

In a fifth aspect, embodiments of the present disclosure provide a terminal device, including:
at least one processor; and
a memory communicatively connected with the at least one processor; and
the memory stores instructions executable by the at least one processor, and the instructions are executed by the at least one processor to cause the at least one processor to implement the method of any one of the first aspect.

In a sixth aspect, embodiments of the present disclosure provide a non-transitory computer-readable storage medium storing computer instructions, and the computer instructions are configured to cause a computer to implement the method according to any one of the first aspect.

In a seventh aspect, embodiments of the present disclosure provide a computer program product including a computer program, and the computer program, when executed by a processor, realizes the method according to any one of the first aspect.

The embodiments of the present disclosure provide a power control method, an apparatus and a terminal equipment, which can determine a minimum of a plurality of transmission powers as a transmission power of a SL-PRS, and transmit the SL-PRS according to the transmission power, so as to realize power control of the SL-PRS. The plurality of transmission powers may include a maximum transmission power of a terminal device and a first transmission power determined based on path loss.

### BRIEF DESCRIPTION OF DRAWINGS

FIG. 1 is a schematic diagram of an application scenario provided by an embodiment of the present disclosure.

FIG. 2 is a schematic flowchart of a power control method provided by an embodiment of the present disclosure.

FIG. 3 is a schematic diagram of a path provided by an embodiment of the present disclosure.

FIG. 4 is a schematic diagram of a slot structure provided by an embodiment of the present disclosure.

FIG. 5A is a schematic diagram of another slot structure provided by an embodiment of the present disclosure.

FIG. 5B is a schematic diagram of yet another slot structure provided by an embodiment of the present disclosure.

FIG. 6 is a schematic diagram of still another slot structure provided by an embodiment of the present disclosure.

FIG. 7A is a schematic diagram of still another slot structure provided by an embodiment of the present disclosure.

FIG. 7B is a schematic diagram of still another slot structure provided by an embodiment of the present disclosure.

FIG. 8 is a schematic structural diagram of a power control apparatus provided by an embodiment of the present disclosure.

FIG. 9 is a schematic structural diagram of a terminal device provided by an embodiment of the present disclosure.

### DESCRIPTION OF EMBODIMENTS

In order to make the purpose, technical scheme and advantages of the embodiment of the present disclosure more clear, the technical scheme in the embodiments of the present disclosure will be described clearly and completely in the following with reference to the accompanying drawings of the embodiments of the present disclosure. Obviously, the described embodiment is a part of the embodiments of the disclosure, but not all of the embodiments. Based on the embodiments of the present disclosure, all other embodiments obtained by those skilled in the art without creative labor falls into the protection scope of the present disclosure.

The technical scheme of the embodiments of the present disclosure can be applied to various communication systems, such as: a Long Term Evolution (LTE) system, a frequency division duplex (FDD) system, a LTE time division duplex (TDD) system, a universal mobile telecommunications system (UMTS), a worldwide interoperability for microwave access (WiMAX) communication system, a 5th Generation (5G) mobile communication system or new radio access technology (NR). The 5G mobile communication system may include non-standalone (NSA) and/or standalone (SA).

The technical scheme provided by the present disclosure can also be applied to a machine type communication (MTC) network, a long-term evolution-machine (LTE-M) network, a device-to-device (D2D) network, a machine-to-machine (M2M) network, Internet of things (IoT) network or other networks. Among them, the IoT network may include, for example, the Internet of Vehicles. Among them, the communication mode in the Internet of vehicle networking system is referred to as vehicle to X (V2X, X may represent anything), for example, V2X may include vehicle to vehicle (V2V) communication, vehicle to infrastructure (V2I) communication, vehicle to pedestrian (V2P) communication or vehicle to network (V2N) communication, etc.

The technical scheme provided by the present disclosure can also be applied to future communication systems, such as the sixth generation mobile communication system, which is not limited by the present disclosure.

In the embodiments of the present disclosure, the network device can be any device with wireless transceiving function. The device includes, but is not limited to, an evolved node B (eNB), a radio network controller (RNC), a node B (NB), a base station controller (BSC), a base transceiver station (BTS), a home base station (for example, a home evolved NodeB, or home Node B, HNB), a baseband unit (BBU), a access point (AP), a wireless relay node, a wireless backhaul node, a transmission point (TP) or a transmission and reception point (TRP) in a wireless fidelity (WiFi) system, etc. The device may also be a the next generation of node B (gNB), or, a transmission point (TRP or TP) in 5G system, such as NR system, one or a group of antenna panels (including a plurality of antenna panels) of a base station in a 5G system, or a network node constituting a gNB or a transmission point, such as a baseband unit (BBU), or a distributed unit (DU), and so on.

A network device provides services for the cell, and a terminal device communicates with the cell through the transmission resources (e.g., frequency domain resources or spectrum resources) allocated by the network device, and the cell could belong to macro site (e.g., macro eNB or macro gNB, etc.) or the cell could belong to a base station corresponding to a small cell. The Small cell herein can include: metro cell, micro cell, pico cell, femto cell, etc. These small cells have the characteristics of small coverage and low transmission power, and are suitable for providing services of high-speed data transmission.

In the embodiment of the present disclosure, the terminal device can also be referred as a user equipment (UE), an access terminal, a user unit, a user station, a mobile station, a mobile site, a remote station, a remote terminal, a mobile device, a user terminal, a terminal, a wireless communication device, a user agent or a user apparatus.

A terminal device may be a device that provides voice/data connectivity to a user, such as a handheld device or a vehicle-mounted device with wireless connection function, and the like. At present, some examples of terminal devices can be: a mobile phone, a tablet computer (pad), a computer with wireless transceiving function (such as a notebook computer, a palmtop, etc.), a mobile internet device (MID), a virtual reality (VR) device, an augmented reality (AR) device, a wireless terminals in industrial control, a wireless terminals in self driving, a wireless terminal in a remote medical, a wireless terminal in a smart grid, a wireless terminal in a transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with a wireless communication function, a computing device or other processing devices, vehicle-mounted devices, wearable devices connected to a wireless modem, a terminal device in a 5G network or a terminal device in a future evolved public land mobile network (PLMN), etc.

Among them, wearable devices can also be referred as wearable smart devices, which is a general term for wearable devices which is developed by applying wearable technology to intelligently design daily wearing, such as glasses, gloves, watches, clothing and shoes. Wearable device is a portable device that is worn directly on the body or integrated into the user's clothes or accessories. Wearable device is not only a kind of hardware device, but also realizes powerful functions through software support, data interaction and cloud interaction. Generally speaking, wearable smart devices include devices with all kinds of functions with a large size, which can realize all of the functions or partial functions without relying on smart phones, such as smart watches or smart glasses; wearable smart devices also include devices that only focus on a certain type of disclosure functions, and need to be used with other devices such as smart phones, such as all kinds of smart bracelets and smart jewelry for monitoring physical characteristic parameters.

In addition, the terminal device can also be the terminal device in the Internet of things (IoT) system. The IoT is an important part of the future development of information technology. Main technical feature of the IoT is to connect things with the network through communication technology, thus realizing the intelligent network of man-machine interconnection and things-things interconnection. The IoT technology can achieve massive connection, deep coverage and power saving of terminal device through, for example, narrow band NB technology.

In addition, the terminal device can also include a smart printer, a train detector, a gas station and other sensors. The main functions of the sensors include collecting data (of some terminal device), receiving control information and downlink data of network device, and sending electromagnetic waves to transmit uplink data to the network device.

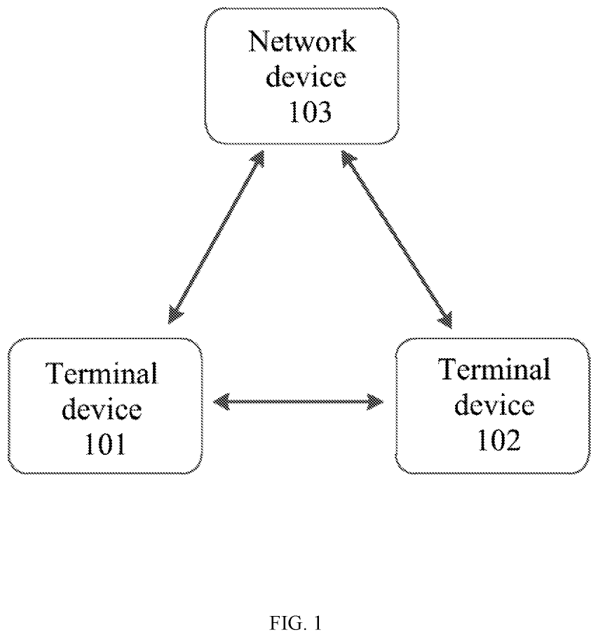

Next, an application scenario is exemplarily illustrated with reference to FIG. 1.

FIG. 1 is a schematic diagram of an application scenario provided by an embodiment of the present disclosure. Please refer to FIG. 1, which includes a terminal device 101 and a terminal device 102, the terminal device 101 and the terminal device 102 can communicate with each other. The communication link between the terminal device 101 and the terminal device 102 may be referred as a sidelink, a side link, a PC5 link, and the like. The terminal device 101 may transmit a SL-PRS to the terminal device 102 to realize positioning of the terminal device 101. The application scenario may also include a network device 103, the network device 103 may communicate with the terminal device 101 and/or the terminal device 102 through an radio interface, for example, for data transmission.

It should be noted that the transmission in the embodiments of the present disclosure includes sending and/or receiving. The application scenario shown in FIG. 1 is just an example. In actual implementation, there may be more or less network devices and more or less terminal devices, which is not limited in the present disclosure.

In the side link positioning scenario, a SL-PRS is mainly used as a positioning measurement signal in various positioning methods. In order to control an interference of a SL-PRS transmission on a side link transmission and/or an air interface transmission, it is necessary to perform power control on a transmission including the SL-PRS. In a related technology of sidelink power control, a maximum transmission power of a terminal device, a maximum transmission power of the terminal device under congestion control constraints and a transmission power determined by path loss measurement are fully considered, and a minimum among the above multiple powers is determined as a transmission power of the SL-PRS. The existing power control scheme may not be completely applicable to a power control scheme including a SL-PRS transmission, resulting in unsatisfactory power control effect, and seriously interferes with transmission of other sidelinks and air interfaces.

The embodiments of the present disclosure can determine a minimum of a plurality of transmission powers as a transmission power of a SL-PRS, and transmit the SL-PRS according to the transmission power, so as to realize power control of the SL-PRS. The plurality of transmission powers may include a maximum transmission power of a terminal device and a first transmission power determined based on path loss, so that the transmission power of the SL-PRS can meet basic power requirements. This method realizes the power control of the SL-PRS and can effectively reduce interference to other links.

Next, the method shown in the present disclosure will be explained through specific embodiments. It should be noted that the following embodiments can exist independently or in combination with each other, and the same or similar contents will not be repeated in different embodiments.

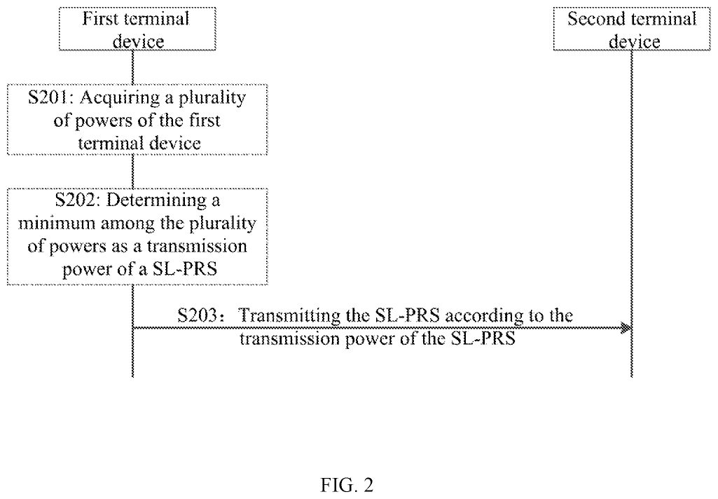

FIG. 2 is a diagram flowchart of a power control method provided by an embodiment of the present disclosure. Referring to FIG. 2, the method may include:

S201: a first terminal device acquires a plurality of powers of the first terminal device.

The execution entity of the embodiment of the present disclosure may be a first terminal device, or a chip, chip module or power control apparatus arranged in the first terminal device. The power control apparatus can be realized by software or by the combination of software and hardware. The embodiment illustrates the technical scheme provided by the present disclosure by taking the first terminal device as an example of the execution entity.

The plurality of power may include a maximum transmission power of the first terminal device and a first transmission power. The first transmission power is a transmission power determined based on path loss.

The maximum transmission power of the first terminal device can be configured by a network device. For example, the network device may send configuration information to the first terminal device, and the configuration information may include the maximum transmission power of the first terminal device. The first terminal device receives the configuration information and determines the maximum transmission power of the first terminal device according to the configuration information.

The path loss for determining the first transmission power may include one or more of the following: sidelink path loss (Sidelink Path-loss, SL Path-loss) of a side link, and downlink path loss (Downlink Path-loss, DL Path-loss) between the network device and the terminal device.

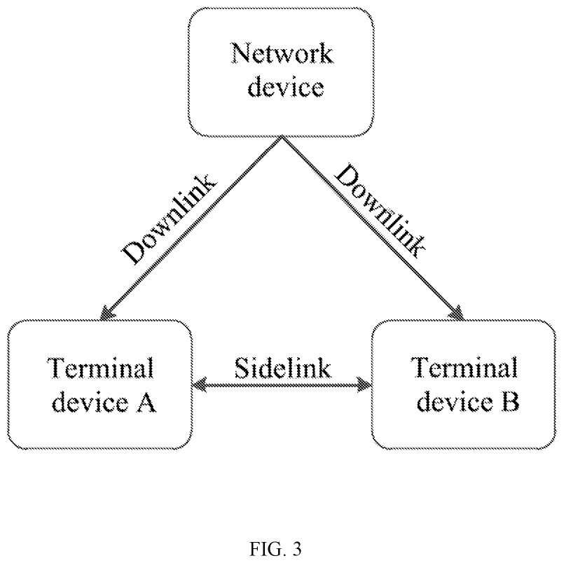

Next, the path loss will be described with reference to FIG. 3.

FIG. 3 is a schematic diagram of a path provided by an embodiment of the present disclosure. Please refer to FIG. 3, a terminal device A, a terminal device B and a network device are included. The terminal device A can communicate with the network device and the terminal device B respectively. The link between the terminal device A and the terminal device B is referred as side link.

Assuming that the terminal device A is the first terminal device, the path loss on which the first transmission power is determined based includes one or more of the following: sidelink path loss between the terminal device A and the terminal device B, and downlink path loss between the terminal device A and the network device.

In an embodiment, the plurality of power may further include a second transmission power. The second transmission power is a maximum available transmission power determined based on a current channel busy ratio (CBR) level and a priority value of transmitted data in a case of congestion control.

Among them, a CBR is used to indicate a busy degree of a channel. The current CBR in the present disclosure is used to indicate a busy degree of a channel currently occupied by the first terminal device, the busy degree of the channel currently occupied by the first terminal device can be determined according to occupancy of the channel in a past period of time.

A priority value of the transmitted data is a priority value of a sidelink transmission. The priority value of the transmitted data may be a priority value indicated in sidelink control information (SCI).

The priority value of the transmitted data can be a preset value, which can be specified by protocol or configured by the network.

The priority value of the transmitted data may be a minimum of a priority value of the SL-PRS and a priority value of sidelink data.

S202: The first terminal device determines a minimum among the plurality of powers as a transmission power of a SL-PRS.

For example, in a case that the plurality of power include the maximum transmission power of the first terminal device and the first transmission power, a minimum of the maximum transmission power of the first terminal device and the first transmission power is determined as the transmission power of the SL-PRS.

S203: The first terminal transmits the SL-PRS according to the transmission power of the SL-PRS. Accordingly, a second terminal device receives the SL-PRS.

It should be noted that the above steps S201-S202 are optional.

The power control method provided by the embodiment of the present disclosure can determine a minimum of a plurality of transmission powers as a transmission power of a SL-PRS, and transmit the SL-PRS according to the transmission power, so as to realize power control of the SL-PRS. The plurality of transmission powers may include a maximum transmission power of a terminal device and a first transmission power determined based on path loss. This method realizes the power control of the SL-PRS and can effectively reduce an interference to other links.

For the convenience of description, the transmission power of the SL-PRS is denoted as P_{SL-PRS}(i), where i is an identification (or referred to as an index) of a time unit, the maximum transmission power of the first terminal device is denoted as P_{CMAX}, the first transmission power is denoted as P1, and the second transmission power is denoted as P_{MAX,CBR}. At this time, the transmission power of the SL-PRS can be determined by the following Formula 1 or Formula 2.

$${P}_{SL - PRS} ( i ) = min ( {P}_{CMAX} , {P}_{MAX , CBR} , P 1 ) [ dBm ] \qquad Formula 1$$

$${P}_{SL - PRS} ( i ) = min ( {P}_{CMAX} , P 1 ) [ dBm ] \qquad Formula 2$$

In the present disclosure, a time unit may include one or more slots (slot), or one or more symbol (symbol), or one or more mini slot (mini slot).

P1 may be determined according to a third transmission power or be determined according to the third transmission power and a fourth transmission power. The third transmission power is a transmission power determined based on downlink path loss. The downlink path loss is path loss of the downlink between the network device and the terminal device. The fourth transmission power is a transmission power determined based on sidelink path loss. The sidelink path loss is path loss of the sidelink between the terminal device and the terminal device.

For example, if the priority value of the transmitted data and the constraint of congestion control are considered, P_{SL-PRS}(i) can be determined by Formula 1.

For example, if the priority value of the transmitted data and/or the constraint of congestion control are not considered, P_{SL-PRS}(i) can be determined by Formula 2.

The third transmission power is denoted as P_{SL-PRS,DL} (i) and the fourth transmission power is denoted as P_{SL-PRS,SL}(i), then P1 can be determined by Formula 3 or Formula 4:

$$P 1 = min ( {P}_{SL - PRS , DL} ( i ) , {P}_{SL - PRS , SL} ( i ) ) . \qquad Formula 3$$

$$P 1 = {P}_{SL - PRS , DL} ( i ) . \qquad Formula 4$$

The following is divided into four parts to explain how to determine the parameters mentioned in the above embodiments. Part I is directed to how to determine P1, part II is directed to how to determine P_{MAX,CBR}, part III is directed to how to determine P_{SL-PRS,DL}(i), and part IV is directed to how to determine P_{SL-PRS,SL}(i).

### Part I: Determination of P1.

Determination method of P1 varies when the conditions satisfied by the first terminal device are different.

In one case, for example, if the first terminal device meets one or more of the conditions for calculating the sidelink path loss, P1 can be determined by Formula 3. And/or, if the first terminal device does not meet all the conditions for calculating the sidelink path loss, then P1 can be determined by Formula 4.

In another case, for example, if the first terminal device meets all the conditions for calculating the sidelink path loss, P1 can be determined by Formula 3. And/or, if the first terminal device does not meet one or more of the conditions for calculating the sidelink path loss, P1 can be determined by Formula 4.

The sidelink path loss may refer to path loss between the first terminal device and the second terminal device. The second terminal device is a terminal device that communicates with the first terminal device, for example, the first terminal device can be the aforementioned terminal device A, and the second terminal device can be the aforementioned terminal device B. The conditions for calculating the sidelink path loss include the following condition 1, condition 2 and condition 3.

Condition 1: The transmission between the first terminal device and a second terminal device is an unicast transmission.

Condition 2: The first terminal device is configured with a preset basic working point of power control based on path loss.

Condition 3: The first terminal device is configured with a reference signal for measuring the sidelink path loss during the communication with the second terminal device.

Unicast transmission refers to point-to-point communication between two terminal devices. For example, for point-to-point communication between the terminal device A and the terminal device B, the transmission between the terminal device A and the terminal device B is a unicast transmission.

In the above condition 2, the basic working point may be a reception power, with which the receiving device (for example, the second terminal device) is expected to receive data.

In the above condition 3, the reference signal used to measure the sidelink path loss is one or more of the following: a demodulation reference signal (DM-RS) in a Physical Sidelink Control Channel (PSCCH); a DM-RS in a Physical Sidelink Shared Channel (PSSCH); an independently configured DM-RS; the SL-PRS. For example, if the SL-PRS and the DM-RS are transmitted in a certain time unit, while other sidelink data is not transmitted in the time unit, the DM-RS can be referred as an independently configured DM-RS.

### Part II: Determination of P_{MAX,CBR}.

P_{MAX,CBR} can be determined according to the priority value of the transmitted data and the current CBR level. Specifically, the current CBR level and its corresponding maximum transmission power are determined according to the priority value of the currently transmitted data. According to the current CBR measurement value, the CBR level where the measurement value is located is determined, and the maximum transmission power corresponding to this CBR level is determined as P_{MAX,CBR}.

The priority value of the transmitted data can be determined by the following mode 1 or mode 2.

Mode 1: The priority value of the transmitted data is determined according to the priority value of the SL-PRS and the priority value of the sidelink data.

For example, the priority value of the transmitted data can be a minimum of the priority value of the SL-PRS and the priority value of the sidelink data.

Mode 2: The priority value of the transmitted data is preset.

For example, the priority value of the transmitted data can be specified by protocol or configured by the network device.

The determination method of the priority value of the transmitted data varies in different situations, which are described in the following cases 1 and 2 respectively.

Case 1: The SL-PRS is multiplexed with the sidelink data in one time unit.

In this case, the priority value of the transmitted data can be determined by Mode 1 or Mode 2.

Case 2: SL-PRS is not multiplexed with the sidelink in one time unit.

In this case, the priority value of the transmitted data can be determined according to the Mode 2.

### Part III: Determination of P_{SL-PRS,DL}(i).

In an embodiment, P_{SL-PRS,DL} (i) can be determined by any one of the following Formula 5 to Formula 7.

$${P}_{SL - PRS , DL} ( i ) = {P}_{O , D} + 10 {log}_{10} ( {2}^{μ} \cdot {M}_{RB}^{SL - PRS} ( i ) ) + {α}_{D} \cdot {PL}_{D} [ dBm ] \qquad Formula 5$$

$${P}_{SL - PRS , DL} ( i ) = min \{ {P}_{CMAX ,} {P}_{MAX , CBR} \} [ dBm ] \qquad Formula 6$$

$${P}_{SL - PRS , DL} ( i ) = {P}_{CMAX} [ dBm ] \qquad Formula 7$$

Among them, P_{O,D} is a basic working point for power control based on downlink path loss. μ is a parameter related to a subcarrier gap, and the subcarrier gap has a corresponding relationship with the value of the parameter related to the subcarrier gap. M_{RB}^{SL-PRS} (i) is the number of frequency domain resource units (e.g. resource blocks, subcarriers, etc.) occupied by the SL-PRS or the number of frequency domain resource units occupied by PSCCH. α_{D} is a compensation factor for downlink path loss. PL_{D} is a measurement for downlink path loss obtained by the first terminal device. For corresponding explanations of other parameters, please refer to the description above.

Determination method for P_{SL-PRS,DL} (i) varies under different situations.

For example, if a high layer signaling configures the basic working point of power control based on the downlink path loss, P_{SL-PRS,DL}(i) can be determined by Formula 5.

For example, if the high layer signaling dose not configure the basic working point of power control based on the downlink path loss, and the priority value of the transmitted data is required to be considered, then P_{SL-PRS,DL}(i)) can be determined by Formula 6.

For example, if the high layer signaling dose not configure the basic working point of power control based on downlink path loss, and the priority value of the transmitted data is not required to be considered, then P_{SL-PRS,DL}(i) can be determined by Formula 7.

### Part IV: Determination of P_{SL-PRS,SL}.

In an embodiment, P_{SL-PRS,SL} (i) can be determined by any one of the following Formula 8 to Formula 10.

$${P}_{SL - PRS , SL} ( i ) = {P}_{O , SL} + 10 {log}_{10} ( {2}^{μ} \cdot {M}_{RB}^{SL - PRS} ( i ) ) + {α}_{SL} \cdot {PL}_{SL} [ dBm ] \qquad Formula 8$$

$${P}_{SL - PRS , SL} ( i ) = min \{ {P}_{CMAX} , {P}_{MAX , CBR} \} [ dBm ] \qquad Formula 9$$

$${P}_{SL - PRS , SL} ( i ) = {P}_{CMAX} [ dBm ] \qquad Formula 10$$

Among them, P_{O,SL} is a basic working point for power control based on sidelink path loss. M_{RB}^{SL-PRS}(i) is the number of frequency domain resource units occupied by the SL-PRS or the number of frequency domain resource units occupied by PSCCH. α_{SL} is a compensation factor for sidelink path loss. PL_{SL} is sidelink path loss estimated by the first terminal device. For explanations of other parameters, please refer to the description above.

In an embodiment, if the number of the frequency domain resource units occupied by the SL-PRS is equal to the number of the frequency domain resource units occupied by the PSCCH, then M_{RB}^{SL-PRS}(i) is the number of the frequency domain resource units occupied by the SL-PRS. If the number of the frequency domain resource units occupied by the SL-PRS is not equal to the number of the frequency domain resource units occupied by the PSCCH, then M_{RB}^{SL-PRS}(i) can be the number of the frequency domain resource units occupied by the SL-PRS or the number of the frequency domain resource units occupied by the PSCCH, which one does the M_{RB}^{SL-PRS}(i) corresponds to can be preset, for example, specified by the protocol or configured by the network device.

PL_{SL} can be determined by calculation and measurement according to the reference signal for measuring the sidelink path loss.

Determination method of P_{SL-PRS,SL}(i) varies under different situations.

For example, if a high layer signaling configures the basic working point of power control based on the sidelink path loss, and the first terminal device communicates with the second terminal device in unicast, then P_{SL-PRS,SL}(i) can be determined by Formula 8.

For example, if the high layer signaling does not configure the basic working point of power control based on the sidelink path loss, and the priority value of the transmitted data and the constraint of congestion control is required to be considered, then P_{SL-PRS,SL}(i) can be determined by Formula 9.

For example, if the high layer signaling does not configure the basic working point of power control based on the sidelink path loss, and the priority value of the transmitted data and/or the constraint of congestion control is not required to be considered, then P_{SL-PRS,SL} (i) can be determined by Formula 10.

Any one of the above determination methods of P_{SL-PRS}(i) can be applied to any of the following situations:

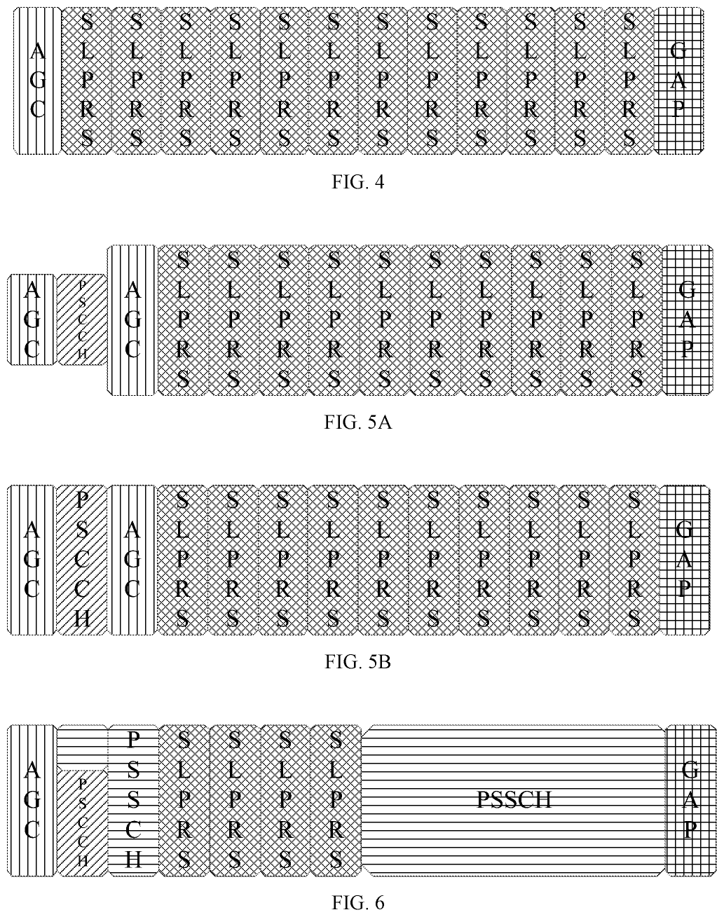

Case A: The SL-PRS is not multiplexed with a sidelink channel (for example, PSCCH) in a same slot. For example, referring to the slot shown n FIG. 4, an automatic gain control (AGC) symbol, a plurality of SL-PRS symbols and a GAP (GAP) symbol are included. In this slot structure, the SL-PRS is transmitted separately, that is, the SL-PRS is not multiplexed with time-frequency resources with other sidelink channels.

Case B: The SL-PRS is multiplexed with the sidelink channel (for example, PSCCH) in a same slot, and the SL-PRS and the sidelink channel correspond to different AGCs. For example, referring to the slots shown in FIG. 5A and FIG. 5B, two AGC symbols, one PSCCH symbol carrying SCI, a plurality of symbols including the SL-PRS and one GAP symbol are included. The SL-PRS and the SCI are multiplexed in this slot structure through time-division multiplexing technology. Among them, there is an AGC before the SL-PRS and the PSCCH, respectively, for automatic gain control. In FIG. 5A, a bandwidth occupied by the SL-PRS is larger than a bandwidth occupied by the PSCCH. In FIG. 5B, the bandwidth occupied by the SL-PRS is equal to the bandwidth occupied by the PSCCH.

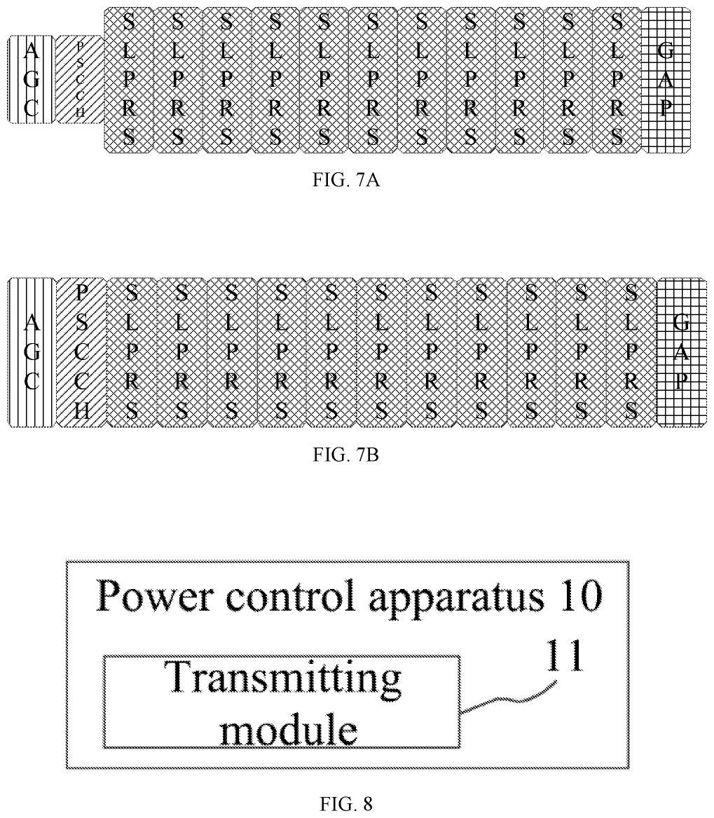

Case C: The SL-PRS is multiplexed with the sidelink channel (for example, PSCCH) in a same slot, and the SL-PRS and the sidelink channel correspond to a same AGC. For example, please refer to the slots shown in FIG. 7A and FIG. 7B, an AGC symbol, a PSCCH symbol carrying SCI, a plurality of symbols containing SL-PRS and a GAP symbol are included. The SL-PRS and the SCI are multiplexed in this slot structure through time-division multiplexing technology, and the SL-PRS and the SCI share an AGC symbol for automatic gain control. In FIG. 7A, a bandwidth occupied by the SL-PRS is larger than a bandwidth occupied by the PSCCH. In FIG. 7B, a bandwidth occupied by the SL-PRS is equal to a bandwidth occupied by the PSCCH.

In an embodiment, in the above cases A and B, M_{RB}^{SL-PRS}(i) in the above formulas is the number of the frequency domain resource units occupied by the SL-PRS. In the above case C, M_{RB}^{SL-PRS}(i) in the above formulas is the number of the frequency domain resource units occupied by the SL-PRS or the PSCCH.

The method for determining the transmission power of the SL-PRS provided by the embodiments of the present disclosure comprehensively considers the priority value of the transmitted data, the constraint of congestion control, the path loss and the number of the frequency domain resource units, and selects a corresponding method for determining the transmission power of the SL-PRS under different conditions (for example, considering the priority value of the transmitted data but not considering the sidelink path loss, etc.). In the above process, when the transmitted data with different slot structures including the SL-PRS, the conditions that need to be considered emphatically can be selected according to the characteristics of the slot structure, so that a corresponding method for determine the transmission power of the SL-PRS can be selected.

In addition to determining P_{SL-PRS}(i) by the aforementioned method, P_{SL-PRS}(i) can be determined by power boosting (power boosting). These two methods can exist at the same time. In this case, before determining P_{SL-PRS}(i), which way to determine P_{SL-PRS}(i) can be determined firstly. There may only be one way to determine P_{SL-PRS}(i), in which case, the P_{SLPRS}(i) is determined with the one way of determining P_{SL-PRS}(i). The process of determining P_{SL-PRS}(i) by power boosting is as follows: P_{SL-PRS}(i) can be determined by the following Formula 11 or Formula 12.

$${P}_{SL - PRS} ( i ) = min ( {P}_{CMAX} , {P}_{MAX , CBR} + {P}_{boosting} , P 1 ) [ dBm ] \qquad Formula 11$$

$${P}_{SL - PRS} ( i ) = min ( {P}_{CMAX} , {P}_{boosting} , P 1 ) [ dBm ] \qquad Formula 12$$

Where P_{boosting} is a power boosting gain of the SL-PRS. For the relevant explanations of other parameters and the determination process, please refer to the description above. Specifically, the P_{boosting} corresponding to the SL-PRS can be determined according to positioning accuracy requirements, positioning methods, and positioning scenes, etc.

The method for determining the transmission power of the SL-PRS provided by the embodiment of the present disclosure introduces a power boosting method on the basis of considering the priority value of the transmitted data, the constraint of congestion control, the path loss and the number of the frequency domain resource units. Power requirements of different positioning requirements are met by boosting power of resource units used by the SL-PRS.

The determination of the transmission power of the SL-PRS is described above, and the determination of the transmission power of the PSCCH is described in the following, specifically:
for the convenience of description, the transmission power of the PSCCH is denoted as P_{PSCCH}(i) below, and i is the identification of the time unit. P_{PSCC}H (i) can be determined by any one of Formula 13 to Formula 15:

$${P}_{PSCCH} ( i ) = min ( {P}_{CMAX} , {P}_{MAX , CBR} , P 2 ) [ dBm ] \qquad Formula 13$$

$${P}_{PSCCH} ( i ) = min ( {P}_{CMAX} , P 2 ) [ dBm ] \qquad Formula 14$$

$${P}_{PSCCH} ( i ) = {P}_{SL - PRS} ( i ) \qquad Formula 15$$

P2 refers to a fifth transmission power, for the meanings of other parameters, please refer to the above description, which is not repeated here. The fifth transmission power is determined according to a sixth transmission power, or the fifth transmission power is determined according to the sixth transmission power and a seventh transmission power. The sixth transmission power is a transmission power determined based on the downlink path loss, and the seventh transmission power is a transmission power determined based on the sidelink path loss.

The sixth transmission power is denoted as P_{PSCCH,DL}(i) and the seventh transmission power is denoted as P_{PSCCH,SL}(i). P2 can be determined by Formula 16 or Formula 17:

$$P 2 = min ( {P}_{PSCCH , DL} ( i ) , {P}_{PSCCH , SL} ( i ) ) \qquad Formula 16$$

$$P 2 = {P}_{PSCCH , DL} ( i ) \qquad Formula 17$$

For the determination manner of P2, please refer to the aforementioned determination manner of P1, for example as follows.

In one case, for example, if the first terminal device meets one or more of the conditions for calculating the sidelink path loss (see above for details), P2 can be determined by Formula 16. And/or, if the first terminal device does not meet all of the conditions for calculating the sidelink path loss, P2 can be determined by Formula 17.

In another case, for example, if the first terminal device meets all the conditions for calculating the sidelink path loss, P2 can be determined by Formula 16. And/or, if the first terminal device does not meet one or more of the conditions for calculating the sidelink path loss, P2 can be determined by Formula 17.

For determination of P_{MAX,CBR}, please refer to the description above.

Determination methods of P_{PSCCH,DL}(i) and P_{PSCCH,SL}(i) are explained in two parts in the following.

### Part I: Determination of P_{PSCCH,DL}(i).

In an embodiment, P_{PSCCH,DL}(i) can be determined by any one of the following Formula 18 to Formula 20.

$${P}_{PSCCH , DL} ( i ) = {P}_{O , D} + 10 {log}_{10} ( {2}^{μ} \cdot {M}_{RB}^{SL \cdot PRS} ( i ) ) + {α}_{D} \cdot {PL}_{D} [ dBm ] \qquad Formula 18$$

$${P}_{PSCCH , DL} ( i ) = min \{ {P}_{CMAX ,} {P}_{MAX , CBR} \} \qquad Formula 19$$

$${P}_{PSCCH , DL} ( i ) = {P}_{CMAX} [ dBm ] \qquad Formula 20$$

Where M_{RB}^{SL-PRS}(i) is the number of the transmission power resource units occupied by the PSSCH. For explanation of other parameters, please refer to the description above.

Determination method of P_{PSCCH,DL}(i) varies under different situations.

For example, if a basic working point of power control based on the downlink path loss is configured by a high-layer signaling, then P_{PSCCH,DL}(i) can be determined by Formula 18.

For example, if the basic working point of power control based on the downlink path loss is not configured by the high-layer signaling, and the priority value of the transmitted data and the constraint of congestion control is required to be considered, then P_{PSCCH,DL}(i) can be determined by Formula 19.

For example, if the basic working point of power control based on the downlink path loss is not configured for the high-layer signaling, and the priority value of the transmitted data and/or the constraint of congestion control is not required to be considered, then P_{PSCCH,DL}(i) can be determined by Formula 20.

### Part II: Determination of P_{PSCCH,SL}(i).

In an embodiment, P_{PSCCH,SL}(i) can be determined by any one of the following Formula 21 to Formula 23.

$${P}_{PSCCH , SL} ( i ) = {P}_{O , SL} + 10 {log}_{10} ( {2}^{μ} \cdot {M}_{RB}^{SL \cdot PRS} ( i ) ) + {α}_{SL} \cdot {PL}_{SL} [ dBm ] \qquad Formula 21$$

$${P}_{PSCCH , SL} ( i ) = min \{ {P}_{CMAX ,} {P}_{MAX , CBR} \} [ dBm ] \qquad Formula 22$$

$${P}_{PSCCH , SL} ( i ) = {P}_{CMAX} [ dBm ] \qquad Formula 23$$

Where M_{RB}^{SL-PRS}(i) is the number of frequency domain resource units occupied by PSCCH. For explanation of other parameters, please refer to the above description.

Determination method of P_{PSCCH,SL}(i) varies under different situations.

For example, if the basic working point of power control based on the sidelink path loss is configured by a high level signaling, then P_{PSCCH,SL}(i) can be determined by Formula 21.

For example, if the basic working point of power control based on the downlink path loss is not configured by the high layer signaling, and the priority value of the transmitted data and the constraint of congestion control is required to be considered, then P_{PSCCH,SL}(i) can be determined by Formula 22.

For example, if the basic working point of power control based on the downlink path loss is not configured by the high-layer signaling, and the priority value of the transmitted data and/or the constraint of congestion control is not required to be considered, then P_{PSCCH,SL}(i) can be determined by Formula 23.

Determination method of P_{PSCCH}(i) will be explained by examples in the following.

For example, in a case that power control on the PSCCH and the SL-PRS is performed independently, for example, in the scenario shown in the above case B, where the PSCCH and the SL-PRS correspond to different AGCs, P_{PSCCH}(i) can be determined by Formula 13 or Formula 14.

For another example, in a case that power control for the PSCCH and the SL-PRS is performed together, for example, in the scenario shown in case C above, when the PSCCH and the SL-PRS correspond to a same AGC, P_{PSCCH}(i) can be determined by Formula 20.

In addition to determining the transmission power of the SL-PRS and the PSCCH by the method described above, in some scenarios, for example, the PSSCH and the SL-PRS are multiplexed in slots, and frequency domain widths of the PSSCH and the SL-PRS are the same, for example, in a case that the SL-PRS is located in the slot shown in FIG. 6 (the slot includes an AGC symbol, a PSCCH symbol, a plurality of SL-PRS symbols, a plurality of PSSCH symbols and a GAP symbol, and the SL-PRS is multiplexed with the PSCCH and the PSSCH in the slot), the transmission power of the SL-PRS can also be the same with the transmission power of the PSSCH (that is, P_{SL-PRS}(i)=P_{PSSCH}(i), and P_{PSSCH}(i) refers to the transmission power of the PSSCH), and for the transmission power of the PSCCH, existing power control scheme can be adopted.

P_{PSSCH}(i) can be determined by the following Formula 24.

$${P}_{PSSCH} ( i ) = \text{} min \text{} ( {P}_{CMAX} , {P}_{MAX , CBR} , min ( {P}_{PSSCH , D} ( i ) , {P}_{PSSCH , SL} ( i ) ) ) [ dBm ] \qquad Formula 24$$

Where P_{PSSCH,D}(i) is a transmission power determined based on the downlink path loss. P_{PSSCH,SL}(i) is a transmission power determined based on the sidelink path loss. For the relevant explanations and determination methods of P_{CMAX} and P_{MAX,CBR}, please refer to the above description.

Determination of P_{PSSCH,D}(i) and P_{PSSCH,SL}(i) mentioned in Formula 24 will be explained in two parts in the following.

### Part I: Determination of P_{PSSCH,D}(i).

In an embodiment, P_{PSSCH,D}(i) can be determined by the following Formula 25 or Formula 26.

$${P}_{PSSCH , D} ( i ) = {P}_{O , D} + 10 {log}_{10} ( {2}^{μ} \cdot {M}_{RB}^{PSSCH} ( i ) ) + {α}_{D} \cdot {PL}_{D} [ dBm ] \qquad Formula 25$$

$${P}_{PSSCH , D} ( i ) = min ( {P}_{CMAX ,} {P}_{MAX , CBR} ) [ dBm ] \qquad Formula 26$$

Where M_{RB}^{PSSCH}(i) is the number of the frequency domain resource units occupied by the PSSCH. For the related explanation of other parameters, please refer to the above description

The determination method of P_{PSSCH,D}(i) varies under different situations.

For example, if the basic working point of power control based on the downlink path loss is configured by the high-layer signaling, P_{PSSCH,D}(i) can be determined by Formula 25.

For example, if the basic working point of power control based on the downlink path loss is not configured by the higher layer signaling, then P_{PSSCH,D}(i) can be determined by Formula 26.

### Part II: Determination of P_{PSSCH,SL}(i).

In an embodiment, P_{PSSCH,SL}(i) can be determined by the following Formula 27 or Formula 28.

$${P}_{PSSCH , SL} ( i ) = {P}_{O , SL} + 10 {log}_{10} ( {2}^{μ} \cdot {M}_{RB}^{PSSCH} ( i ) ) + {a}_{SL} \cdot {PL}_{SL} [ dBm ] \qquad Formula 27$$

$${P}_{PSSCH , SL} ( i ) - min ( {P}_{CMAX} , {P}_{PSSCH , D} ( i ) ) [ dBm ] \qquad Formula 28$$

For relevant explanations of parameters in Formula 27 and Formula 28, please refer to the description above.

The determination method of P_{PSSCH,SL}(i) varies under different situations.

For example, if the basic working point of power control based on the sidelink path loss is configured by the high-layer signaling, P_{PSSCH,SL}(i) can be determined by Formula 27.

For example, if the basic working point of power control based on the sidelink path loss is not configured by the high layer signaling, then P_{PSSCH,SL}(i) can be determined by Formula 28.

The method for determining the transmission power of the SL-PRS and the PSCCH provided by the embodiments of the present disclosure can directly determine the transmission power of the SL-PRS by using the existing protocol when the SL-PRS is multiplexed with the PSCCH in a same slot. On the basis of realizing the power control of SL-PRS, consistency on the power control in the whole slot can be achieved.

It should be noted that the PSCCH in the above embodiment of the present disclosure may include part or all of the SCI, for example, the PSCCH may include only First-stage SCI (1st-stage SCI) or Second-stage SCI (2nd-stage SCI), or both the First-stage SCI (1st-stage SCI) and the Second-stage SCI (2nd-stage SCI).

Embodiments of the present disclosure provide a power control method, which are configured for solving an interference problem of a sidelink transmission including a SL-PRS to other sidelink transmissions and an air interface transmission. With the aforementioned method, the power control of the SL-PRS is realized, and interference to other links can be effectively reduced.

FIG. 8 is a structural schematic diagram of a power control apparatus 10 provided by an embodiment of the present disclosure. The power control apparatus 10 may be a first terminal device, or a chip or chip module in the first terminal device. Referring to FIG. 8, the power control apparatus 10 may include:
a transmitting module, configured to transmit a sidelink positioning reference signal SL-PRS according to a transmission power of the SL-PRS, wherein the transmission power of the SL-PRS is a minimum among a plurality of powers, and the plurality of powers comprise a maximum transmission power of the apparatus and a first transmission power, and the first transmission power is a transmission power determined based on path loss.

The power control apparatus provided by the embodiment of the present disclosure can implement the technical scheme shown in the above method embodiment, and its implementation principle and beneficial effects are similar, which will not be repeated here.

In a possible implementation, the plurality of powers further include a second transmission power, where the second transmission power is a maximum available transmission power determined based on a CBR level and a priority value of transmitted data in a case of congestion control.

In a possible implementation, the priority value of the transmitted data is:
a minimum of a priority value of the SL-PRS and a priority value of sidelink data; or,
a preset priority value.

In a possible implementation, the priority value of the transmitted data is the preset priority value in a case that the SL-PRS is not multiplexed with the sidelink data in one time unit; and/or,
the priority value of the transmitted data is: the minimum of the priority value of the SL-PRS and the priority value of the sidelink data, or the preset priority value in a case that the SL-PRS is multiplexed with the sidelink data in one time unit.

In a possible implementation, the first transmission power is determined according to a third transmission power and a fourth transmission power; or,
the first transmission power is determined according to the third transmission power;
where the third transmission power is a transmission power determined based on downlink path loss, and the fourth transmission power is a transmission power determined based on sidelink path loss.

In a possible implementation, in a case that the first transmission power is determined according to the third transmission power and the fourth transmission power, the first transmission power is a minimum of the third transmission power and the fourth transmission power.

In a possible implementation, in a case that the first transmission power is determined according to the third transmission power and the fourth transmission power, the first terminal device satisfies one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

In a possible implementation, in a case that the first transmission power is determined according to the third transmission power, the first terminal device does not satisfy one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

In a possible implementation, the reference signal for measuring the sidelink path loss is one or more of the following:
a demodulation reference signal DM-RS in a physical sidelink control channel PSCCH;
a DM-RS in a physical sidelink shared channel PSSCH;
an independently configured DM-RS;
the SL-PRS.

In a possible implementation, the third transmission power is determined according to one or more of the following parameters:
a basic working point of power control based on downlink path loss;
a sub carrier gap;
the number of frequency domain resource units occupied by the SL-PRS or the number of frequency domain resource units occupied by sidelink control information SCI;
a compensation factor for downlink path loss; and
a measurement for downlink path loss obtained by the first terminal device.

In a possible implementation, the third transmission power is a minimum of the maximum transmission power and a second transmission power;
where the second transmission power is a maximum available transmission power determined based on a current CBR level and a priority value of transmitted data in a case of congestion control.

In a possible implementation, the third transmission power is the maximum transmission power.

In a possible implementation, the fourth transmission power is determined according to one or more of the following parameters:
a basic working point of power control based on sidelink path loss;
a sub-carrier gap;
the number of frequency domain resource units occupied by the SL-PRS or the number of frequency domain resource units occupied by SCI;
a compensation factor for sidelink path loss; and
sidelink path loss estimated by the first terminal device.

In a possible implementation, the fourth transmission power is a minimum of the maximum transmission power and a second transmission power;
where the second transmission power is a maximum available transmission power determined based on a current CBR level and a priority value of transmitted data in a case of congestion control.

In a possible implementation, the fourth transmission power is the maximum transmission power.

The power control apparatus provided by the embodiment of the present disclosure can implement the technical scheme shown in the above method embodiment, and their implementation principle and beneficial effects are similar, which will not be repeated here. The power control method apparatus is configured for solving an interference problem of a sidelink transmission including a SL-PRS to other sidelink transmissions and an air interface transmission.

In a first aspect, embodiments of the present disclosure provide a power control method, where the method is applied to a first terminal device, and the method includes: transmitting a SL-PRS according to a transmission power of the SL-PRS, where the transmission power of the SL-PRS is a minimum among a plurality of powers, and the plurality of powers include a maximum transmission power of the first terminal device and a first transmission power, and the first transmission power is a transmission power determined based on path loss.

In a possible implementation, the plurality of powers further include a second transmission power, where the second transmission power is a maximum available transmission power determined based on a CBR level and a priority value of transmitted data in a case of congestion control.

In a possible implementation, the priority value of the transmitted data is:
a minimum of a priority value of the SL-PRS and a priority value of sidelink data; or,
a preset priority value.

In a possible implementation, the priority value of the transmitted data is the preset priority value in a case that the SL-PRS is not multiplexed with the sidelink data in one time unit; and/or,
the priority value of the transmitted data is: the minimum of the priority value of the SL-PRS and the priority value of the sidelink data, or the preset priority value in a case that the SL-PRS is multiplexed with the sidelink data in one time unit.

In a possible implementation, the first transmission power is determined according to a third transmission power and a fourth transmission power; or,
the first transmission power is determined according to the third transmission power;
where the third transmission power is a transmission power determined based on downlink path loss, and the fourth transmission power is a transmission power determined based on sidelink path loss.

In a possible implementation, in a case that the first transmission power is determined according to the third transmission power and the fourth transmission power, the first transmission power is a minimum of the third transmission power and the fourth transmission power.

In a possible implementation, in a case that the first transmission power is determined according to the third transmission power and the fourth transmission power, the first terminal device satisfies one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

In a possible implementation, in a case that the first transmission power is determined according to the third transmission power, the first terminal device does not satisfy one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

In a possible implementation, the reference signal for measuring the sidelink path loss is one or more of the following:
a demodulation reference signal DM-RS in a physical sidelink control channel PSCCH;
a DM-RS in a physical sidelink shared channel PSSCH;
an independently configured DM-RS;
the SL-PRS.

In a possible implementation, the third transmission power is determined according to one or more of the following parameters:
a basic working point of power control based on downlink path loss;
a sub-carrier gap;
the number of frequency domain resource units occupied by the SL-PRS or the number of frequency domain resource units occupied by sidelink control information SCI;
a compensation factor for downlink path loss; and
a measurement for downlink path loss obtained by the first terminal device.

In a possible implementation, the third transmission power is a minimum of the maximum transmission power and a second transmission power;
where the second transmission power is a maximum available transmission power determined based on a current CBR level and a priority value of transmitted data in a case of congestion control.

In a possible implementation, the third transmission power is the maximum transmission power.

In a possible implementation, the fourth transmission power is determined according to one or more of the following parameters:
a basic working point of power control based on the sidelink path loss;
a sub-carrier gap;
the number of frequency domain resource units occupied by the SL-PRS or the number of frequency domain resource units occupied by SCI;
a compensation factor for sidelink path loss; and
sidelink path loss estimated by the first terminal device.

In a possible implementation, the fourth transmission power is a minimum of the maximum transmission power and a second transmission power;
where the second transmission power is a maximum available transmission power determined based on a current CBR level and a priority value of transmitted data in a case of congestion control.

In a possible implementation, the fourth transmission power is the maximum transmission power.

In a second aspect, embodiments of the present disclosure provide a power control apparatus, including:
a transmitting module, configured to transmit a SL-PRS according to a transmission power of the SL-PRS, where the transmission power of the SL-PRS is a minimum among a plurality of powers, and the plurality of powers include a maximum transmission power of the apparatus and a first transmission power, and the first transmission power is a transmission power determined based on path loss.

In a possible implementation, the plurality of powers further include a second transmission power, where the second transmission power is a maximum available transmission power determined based on a CBR level and a priority value of transmitted data in a case of congestion control.

In a possible implementation, the priority value of the transmitted data is:
a minimum of a priority value of the SL-PRS and a priority value of sidelink data; or,
a preset priority value.

In a possible implementation, the priority value of the transmitted data is the preset priority value in a case that the SL-PRS is not multiplexed with the sidelink data in one time unit; and/or,
the priority value of the transmitted data is: the minimum of the priority value of the SL-PRS and the priority value of the sidelink data, or the preset priority value in a case that the SL-PRS is multiplexed with the sidelink data in one time unit.

In a possible implementation, the first transmission power is determined according to a third transmission power and a fourth transmission power; or,
the first transmission power is determined according to the third transmission power;
where the third transmission power is a transmission power determined based on downlink path loss, and the fourth transmission power is a transmission power determined based on sidelink path loss.

In a possible implementation, in a case that the first transmission power is determined according to the third transmission power and the fourth transmission power, the first transmission power is a minimum of the third transmission power and the fourth transmission power.

In a possible implementation, in a case that the first transmission power is determined according to the third transmission power and the fourth transmission power, the first terminal device satisfies one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

In a possible implementation, in a case that the first transmission power is determined according to the third transmission power, the first terminal device does not satisfy one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

In a possible implementation, the reference signal for measuring the sidelink path loss is one or more of the following:
a demodulation reference signal DM-RS in a physical sidelink control channel PSCCH;
a DM-RS in a physical sidelink shared channel PSSCH;
an independently configured DM-RS;
the SL-PRS.

In a possible implementation, the third transmission power is determined according to one or more of the following parameters:
a basic working point of power control based on downlink path loss;
a sub carrier gap;
the number of frequency domain resource units occupied by the SL-PRS or the number of frequency domain resource units occupied by sidelink control information SCI;
a compensation factor for downlink path loss; and
a measurement for downlink path loss obtained by the first terminal device.

In a possible implementation, the third transmission power is a minimum of the maximum transmission power and a second transmission power;
where the second transmission power is a maximum available transmission power determined based on a current CBR level and a priority value of transmitted data in a case of congestion control.

In a possible implementation, the third transmission power is the maximum transmission power.

In a possible implementation, the fourth transmission power is determined according to one or more of the following parameters:
a basic working point of power control based on sidelink path loss;
a sub-carrier gap;
the number of frequency domain resource units occupied by the SL-PRS or the number of frequency domain resource units occupied by SCI;
a compensation factor for sidelink path loss; and
sidelink path loss estimated by the first terminal device.

In a possible implementation, the fourth transmission power is a minimum of the maximum transmission power and a second transmission power;
where the second transmission power is a maximum available transmission power determined based on a current CBR level and a priority value of transmitted data in a case of congestion control.

In a possible implementation, the fourth transmission power is the maximum transmission power.

In a third aspect, the present disclosure provides a chip on which a computer program is stored, and the computer program, when executed by the chip, realizes the method according to any one of the first aspects.

In a fourth aspect, the present disclosure provides a chip module, on which a computer program is stored, and the computer program, when executed by the chip module, realizes the method according to any one of the first aspects.

In a fifth aspect, embodiments of the present disclosure provide a terminal device, including:
at least one processor; and
a memory communicatively connected with the at least one processor; and
the memory stores instructions executable by the at least one processor, and the instructions are executed by the at least one processor to cause the at least one processor to implement the method of any one of the first aspect.

In a sixth aspect, embodiments of the present disclosure provide a non-transitory computer-readable storage medium storing computer instructions, and the computer instructions are configured to cause a computer to implement the method according to any one of the first aspect.

In a seventh aspect, embodiments of the present disclosure provide a computer program product including a computer program, and the computer program, when executed by a processor, realizes the method according to any one of the first aspect.

Embodiments of the present disclosure provide a power control method, an apparatus and a terminal equipment, which can determine a minimum of a plurality of transmission powers as a transmission power of a SL-PRS, and transmit the SL-PRS according to the transmission power, so as to realize power control of the SL-PRS. The plurality of transmission powers may include a maximum transmission power of a terminal device and a first transmission power determined based on path loss. With the aforementioned method, the power control of the SL-PRS is realized, and interference to other links can be effectively reduced.

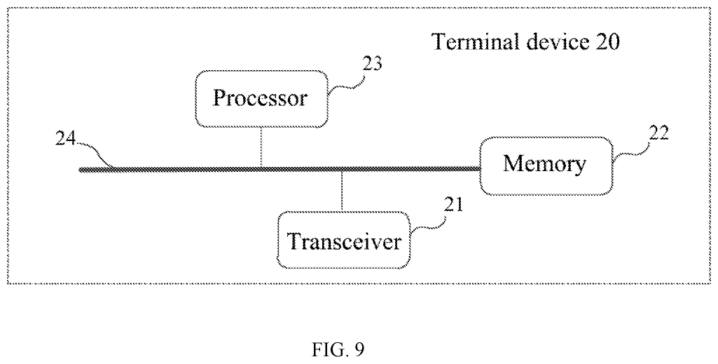

FIG. 9 is a schematic structural diagram of a terminal device provided by an embodiment of the present disclosure, and the terminal device may be the first terminal device mentioned above exemplary. Referring to FIG. 9, the terminal device 20 includes a transceiver 21, a memory 22 and a processor 23. The transceiver 21 may include a transmitter and/or a receiver. The transmitter can also be referred as sender, transmitter, sending port or sending interface and the like, and the receiver can also be referred as receiver, receiving equipment, receiving port or receiving interface and the like. Illustratively, the transceiver 21, the memory 22, and the processor 23 are interconnected by a bus 24.

The memory 22 is configured for storing program instructions.

The processor 23 is configured to execute the program instructions stored in the memory, so as to cause the terminal device 20 to implement any of the above-mentioned power control method.

The transceiver 21 is configured to perform the transceiving function of the terminal device 20 in the above method for determining sidelink resources.

The terminal device provided by the embodiment of the present disclosure can execute the technical scheme illustrated in the above method embodiment with similar implementation principle and beneficial effects, which will not be repeated here.

The embodiment of the disclosure provides a computer-readable storage medium, the computer-readable storage medium stores computer execution instructions, and the computer-executable instructions, when executed by a processor, realize the method as described in the aforementioned embodiments.

Embodiments of the present disclosure can also provide a computer program product, including a computer program, which, when executed by a processor, realizes the method as described in the aforementioned embodiments.

All or part of the steps to implement the above method embodiments can be completed by hardware related to program instructions. The aforementioned program can be stored in a readable memory. When the program is executed, the steps including the above method embodiments are executed. The aforementioned memory (storage medium) includes: read-only memory (abbreviated as ROM), Random Access Memory (abbreviated as RAM), flash memory, hard disk, solid state disk, magnetic tape, floppy disk and optical disc and any of their combination.

Embodiment of the present disclosure are described with reference to flowchart and/or block diagrams of methods, devices (system) and computer program products according to embodiments of the present disclosure. It should be understood that each flow and/or block in the flowchart and/or block diagram, and combinations of the flow and/or block in the flowchart and/or block diagram can be implemented by computer program instructions. These computer program instructions may be provided to the processing unit of a general-purpose computer, a special-purpose computer, an embedded processor or other programmable data processing apparatus to produce a machine, such that the instructions executed by the processing unit of the computer or other programmable data processing device produce means for implementing the functions specified in one or more flows of the flowchart and/or in one or more block of the block diagram.

These computer program instructions may also be stored in a computer-readable memory that can direct a computer or other programmable data processing apparatus to function in a particular manner, such that the instructions stored in the computer-readable memory produce an article of manufacture including instruction means that implement the functions specified in one or more flows of the flowchart and/or in one or more block of the block diagram.

These computer program instructions may also be loaded onto a computer or other programmable data processing device, such that a series of operational steps are performed on the computer or other programmable apparatus to produce a computer-implemented process, such that the instructions executed on the computer or other programmable apparatus provide steps for implementing the functions specified in one or more flows of the flowchart and/or in one or more block of the block diagram.

Obviously, those skilled in the art can make various modifications and variations to the embodiments of the present disclosure without departing from the spirit and scope of the present disclosure. Thus, if these modifications and variations of the embodiments of this disclosure are within the scope of the claims of this disclosure and their equivalents, this disclosure is also intended to include these modifications and variations.

In this disclosure, the term “including” and its variants may refer to including without limitation. The term “or” and its variants may refer to “and/or”. In this disclosure, the terms “first”, “second” and so on are used to distinguish similar objects, and are not necessarily used to describe a specific order or precedence. In this disclosure, “a plurality of” refers to two or more. “and/or”, which describes relationship of related objects, means that there can be three kinds of relationships, for example, A and/or B could represent three situation that A exists alone, A and B exist together, and B exists alone. The character “/” generally indicates that the object before and after the character is in an “or” relationship.

1. A power control method, wherein the method is applied to a first terminal device, and the method comprises:
transmitting a sidelink positioning reference signal (SL-PRS) according to a transmission power of the SL-PRS, wherein the transmission power of the SL-PRS is a minimum among a plurality of powers, and the plurality of powers comprise a maximum transmission power of the first terminal device and a first transmission power, and the first transmission power is a transmission power determined based on path loss.

2. The method according to claim 1, wherein the plurality of powers further comprise a second transmission power, wherein the second transmission power is a maximum available transmission power determined based on a current channel busy ratio CBR) level and a priority value of transmitted data in a case of congestion control.

3. The method according to claim 2, wherein the priority value of the transmitted data is:
a minimum of a priority value of the SL-PRS and a priority value of sidelink data; or,
a preset priority value.

4. The method according to claim 3, wherein, the priority value of the transmitted data is at least one of the following:
the preset priority value in a case that the SL-PRS is not multiplexed with the sidelink data in one time unit;
the minimum of the priority value of the SL-PRS and the priority value of the sidelink data, or the preset priority value in a case that the SL-PRS is multiplexed with the sidelink data in one time unit.

5. The method according to claim 1, wherein the first transmission power is determined according to a third transmission power and a fourth transmission power; or,
the first transmission power is determined according to the third transmission power;
wherein the third transmission power is a transmission power determined based on downlink path loss, and the fourth transmission power is a transmission power determined based on sidelink path loss.

6. The method according to claim 5, wherein in a case that the first transmission power is determined according to the third transmission power and the fourth transmission power, the first transmission power is a minimum of the third transmission power and the fourth transmission power.

7. The method according to claim 5, wherein in a case that the first transmission power is determined according to the third transmission power and the fourth transmission power, the first terminal device satisfies one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

8. The method according to claim 5, wherein in a case that the first transmission power is determined according to the third transmission power, the first terminal device does not satisfy one or more of the following conditions:
a transmission between the first terminal device and a second terminal device is an unicast transmission;
the first terminal device is configured with a preset basic working point of power control based on path loss; and
the first terminal device is configured with a reference signal for measuring the sidelink path loss during the communication with the second terminal device.

9. The method according to claim 7, wherein the reference signal for measuring the sidelink path loss is one or more of the following:
a demodulation reference signal (DM-RS) in a physical sidelink control channel (PSCCH);
a DM-RS in a physical sidelink shared channel (PSCCH);
an independently configured DM-RS;
the SL-PRS.

10. The method according to claim 4, wherein the third transmission power is determined according to one or more of the following parameters:
a basic working point of power control based on downlink path loss;
a sub carrier gap;
the number of frequency domain resource units occupied by the SL-PRS or the number of frequency domain resource units occupied by sidelink control information (SCI);
a compensation factor for downlink path loss; and
a measurement for downlink path loss obtained by the first terminal device.

11. The method according to claim 5, wherein the third transmission power is a minimum of the maximum transmission power and a second transmission power;
wherein the second transmission power is a maximum available transmission power determined based on a current CBR level and a priority value of transmitted data in a case of congestion control.

12. The method according to claim 5, wherein the third transmission power is the maximum transmission power.

13. The method according to claim 5, wherein the fourth transmission power is determined according to one or more of the following parameters:
a basic working point of power control based on sidelink path loss;
a sub-carrier gap;
the number of frequency domain resource units occupied by the SL-PRS or the number of frequency domain resource units occupied by SCI;
a compensation factor for sidelink path loss; and
sidelink path loss estimated by the first terminal device.

14. The method according to claim 5, wherein the fourth transmission power is a minimum of the maximum transmission power and a second transmission power;
wherein the second transmission power is a maximum available transmission power determined based on a current CBR level and a priority value of transmitted data in a case of congestion control.

15. The method according to claim 5, wherein the fourth transmission power is the maximum transmission power.

16. A power control apparatus, comprising:
at least one processor and a memory;
the memory stores computer executable instructions;
the at least one processor executes the computer executable instructions stored in the memory to:
transmit a sidelink positioning reference signal (SL-PRS) according to a transmission power of the SL-PRS, wherein the transmission power of the SL-PRS is a minimum among a plurality of powers, and the plurality of powers comprise a maximum transmission power of the apparatus and a first transmission power, and the first transmission power is a transmission power determined based on path loss.

17. (canceled)

18. A non-transitory computer-readable storage medium storing computer instructions, wherein the computer instructions are configured to cause a computer
transmit a sidelink positioning reference signal (SL-PRS) according to a transmission power of the SL-PRS, wherein the transmission power of the SL-PRS is a minimum among a plurality of powers, and the plurality of power comprise a maximum transmission power of the apparatus and a first transmission power, and the first transmission power is a transmission power determined based on path loss.

19. A computer program product comprising a computer program, wherein the computer program, when executed by a processor, realizes the method according to claim 1.

20. The apparatus according to claim 16, wherein the plurality of powers further comprise a second transmission power, wherein the second transmission power is a maximum available transmission power determined based on a current channel busy ratio (CBR) level and a priority value of transmitted data in a case of congestion control.

21. The apparatus according to claim 20, wherein the priority value of the transmitted data is:
a minimum of a priority value of the SL-PRS and a priority value of sidelink data; or,
a preset priority value.
